(19) United States
(12) Patent Application Publication
(10) Pub. No.: US 2022/0268995 A1
(43) Pub. Date: Aug. 25, 2022

(54) THIN FILM OPTICAL WAVEGUIDE AND PREPARATION METHOD THEREFOR

(71) Applicant: IRIXI PHOTONICS (SUZHOU) CO., LTD., Suzhou (CN)

(72) Inventors: Yifan CHEN, Suzhou (CN); Meng HUANG, Suzhou (CN)

(21) Appl. No.: 17/632,809

(22) PCT Filed: Nov. 18, 2020
(86) PCT No.: PCT/CN2020/129669

§ 371 Date: Feb. 4, 2022

(30) Foreign Application Priority Data
Dec. 25, 2019 (CN) 201911360469.5

(51) Int. Cl. G02B 6/122; G02B 6/132

(52) U.S. Cl. CPC G02B 6/122; G02B 6/132; G02B 2006/12061

(57) ABSTRACT

A thin film optical waveguide includes a silicon-based substrate, a cladding layer arranged on the silicon-based substrate, and an optical waveguide core layer arranged on the silicon-based substrate. The optical waveguide core layer is arranged in the cladding layer, the refractive index of the optical waveguide core layer is higher than that of the cladding layer, the optical waveguide core layer comprises a double-layer optical waveguide dielectric thin film and a thin film material interlayer arranged between the double-layer optical waveguide dielectric thin film, the thin film material interlayer has a two-dimensional lattice sub-wavelength structure, and the thin film material interlayer is a negative thermo-optical coefficient material used for performing thermo-optical coefficient compensation on the optical waveguide dielectric thin film.

### CROSS REFERENCE TO RELATED APPLICATIONS

This application claims priority of Chinese Patent Application No. 201911360469.5, filed Dec. 25, 2019, the entire disclosures of both of which are incorporated herein by reference.

### FIELD OF THE INVENTION

This application relates to a thin film optical waveguide and preparation method therefor.

DESCRIPTION OF THE PRIOR ART

Two-dimensional lattice sub-wavelength thin film optical waveguide is a new type single-mode optical waveguide using subwavelength characteristics. The optical waveguide is composed of a silica film, an optical waveguide dielectric thin film, a two-dimensional lattice thin film material interlayer arranged at the center of the optical waveguide dielectric thin film, and a silica cladding layer covering the optical waveguide dielectric thin film and the two-dimensional lattice thin film material interlayer. The lattice constant of the two-dimensional lattice in the optical waveguide is generally below 400 nm, which is much lower than the propagation wavelength, and the diffraction of light is suppressed. Therefore, it can be equivalent to the uniform dielectric optical waveguide, which is very suitable for the wavelength range of 1310 nm and 1550 nm in traditional optical communication. The low loss characteristics of the optical waveguide make it an ideal optical waveguide structure for a variety of optoelectronic devices, such as Mach-Zehnder modulator, micro-ring resonator etc. Common optical waveguide dielectric thin film materials, such as silicon, doped silica or lithium niobate, all have positive thermal optical coefficient, so their refractive index will also increase when the temperature increases, resulting in an increase of the effective refractive index of the optical waveguide. Since the effective refractive index of optical waveguide is one of the important parameters of device performance, the increase of effective refractive index with the increase of temperature will seriously affect the working efficiency of the device. During the normal use of optical waveguide, its temperature often changes greatly, so thermal stability is one of the important factors determining the practical application ability of an optical waveguide. The common temperature control means include the temperature control system which is actively adjusted according to the feedback. However, this method can't enhance the inherent thermal stability of the optical waveguide, and it also increases the complexity of the system, and can't ensure uniform temperature control. Non-thermal sensitive optical waveguide structure with negative thermo-optical coefficient coating requires additional negative thermo-optical coefficient coating, which increases the complexity and cost of the process.

### BRIEF SUMMARY OF THE INVENTION

The present invention aims to provide a thin film optical waveguide with thermal stability by using negative thermo-optical coefficient material of the two-dimensional lattice sub-waveguide thin film optical waveguide to perform thermo-optical coefficient compensation on the optical waveguide dielectric thin film.

To achieve the above purposes, the present invention is realized as the follow technical solution:

a thin film optical waveguide, including a silicon-based substrate, a cladding layer arranged on the silicon-based substrate, and an optical waveguide core layer arranged on the silicon-based substrate, wherein the optical waveguide core layer is arranged in the cladding layer, the refractive index of the optical waveguide core layer is higher than that of the cladding layer, the optical waveguide core layer comprises a double-layer optical waveguide dielectric thin film and a thin film material interlayer arranged between the double-layer optical waveguide dielectric thin film, the thin film material interlayer has a two-dimensional lattice sub-wavelength structure, and the thin film material interlayer is a negative thermo-optical coefficient material used for performing thermo-optical coefficient compensation on the optical waveguide dielectric thin film.

Further, the negative thermo-optical coefficient material is one of titanium dioxide, zinc oxide and magnesium doped zinc oxide.

Further, the effective thermo-optical coefficient of the negative thermo-optical coefficient material is inversely related to the thickness of the negative thermo-optical coefficient material.

Further, the optical waveguide dielectric thin film is a positive thermo-optical coefficient material.

Further, the optical waveguide dielectric thin film is doped silica.

Further, the doped silica is 2% germanium doped silica.

Further, the two-dimensional lattice sub-wavelength structure is Bravais lattice structure or quasicrystal structure.

Further, the Bravais lattice structure is comprised of square or hexagon.

Further, the quasicrystal structure is octagon or decagon or dodecagon.

Further, the two-dimensional lattice sub-wavelength structure comprises lattice points that are one of circular, elliptical, criss-cross, hexagonal, and octagonal.

The invention also provides a preparation method of the thin film optical waveguide, and the preparation method is as follows:

S1, providing a silicon-based substrate, and forming a lower optical waveguide dielectric thin film on the silicon-based substrate;

S2, preparing a thin film material interlayer by using a negative thermo-optical coefficient material;

S3, preparing the thin film material interlayer into the two-dimensional lattice sub-wavelength structure;

S4, preparing an upper layer optical waveguide dielectric thin film, wherein the lower layer optical waveguide dielectric thin film and the upper layer optical waveguide dielectric thin film form the double-layer optical waveguide dielectric thin film;

S5, preparing the cladding layer.

The beneficial effect of the present invention is: the thin film material interlayer of the thin film optical waveguide provided by the present invention is a negative thermal-optical coefficient material, which is used to perform thermo-optical coefficient compensation on the optical waveguide dielectric thin film, so an additional negative thermo-optical coefficient coating does not need to be arranged, so as to reduce the complexity and cost of the process, ensure the uniform temperature control, simplify the structure of the thin film optical waveguide, and ensure the thermal stability of the thin film optical waveguide.

The above description is only an outline of the technical schemes of the present invention. Preferred embodiments of the present invention are provided below in conjunction with the attached drawings to enable one with ordinary skill in the art to better understand said and other objectives, features, and advantages of the present invention and to make the present invention accordingly.

### BRIEF DESCRIPTION OF THE DRAWINGS

FIG. 1 is a structural diagram depicting the thin film optical waveguide with a two-dimensional lattice sub-wavelength in one embodiment of the present invention.

FIG. 2 is a structural diagram depicting the thin film optical waveguide in FIG. 1 at another direction.

FIG. 3 shows the effective refractive index of the thin film optical waveguide with thermo-optical coefficient compensation in FIG. 1 at different temperatures.

FIG. 4 shows the effective refractive index of the thin film optical waveguide in FIG. 1 with different titanium dioxide thickness.

### DETAILED DESCRIPTION OF THE PREFERRED EMBODIMENTS

Specific embodiments of the present invention are described in further detail in combination with the related drawings and embodiments below. However, in addition to the descriptions given below, the present invention can be applied to other embodiments, and the scope of the present invention is not limited by such, rather by the scope of the claims.

In the description of the invention, it should be noted that the orientation or position relations indicated by the terms “center”, “up”, “down”, “left”, “right”, “vertical”, “horizontal”, “inside” and “outside” are based on the orientation or position relations shown in the attached drawings for the convenience of describing the invention and simplifying the description, rather than indicate or imply the mechanisms or elements must be constructed and operated in the particular orientation and shall not be construed as a limitation of the invention. In addition, the terms “first”, “second” and “third” are used for descriptive purposes only and are not to be understood to indicate or imply relative importance.

In the description of the invention, it should be noted that, unless otherwise expressly specified and qualified, the terms “mounting”, “connecting” and “connection” should be understood in a broad sense, for example, a fixed connection, a detachable connection, or an integrated connection; It can be mechanical or electrical; It can be directly connected or indirectly connected with an intermediary. It can be connected within two components. For ordinary technicians in the field, the specific meanings of the above terms in the present invention can be understood on a case-by-case basis.

Furthermore, the technical features involved in the different embodiments of the invention described below may be combined with each other provided that they do not conflict with each other.

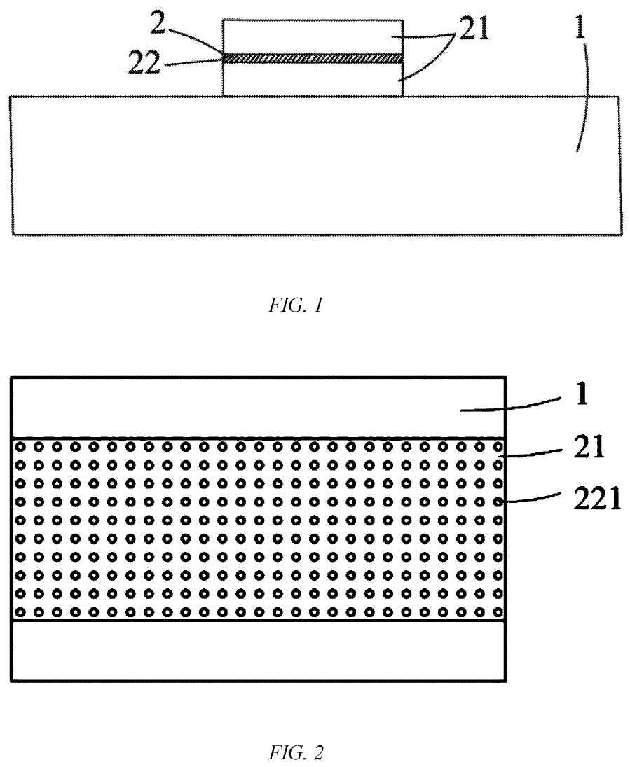

Referring to FIG. 1 and FIG. 2, the thin-film optical waveguide shown in an embodiment of the present invention includes a silicon-based substrate 1, an optical waveguide core layer 2 arranged on the silicon-based substrate 1, and a cladding layer (not shown) arranged on the silicon-based substrate 1. The optical waveguide core layer 2 is arranged in the cladding layer, and the refractive index of the optical waveguide core layer 2 is higher than that of the cladding layer. Specifically, the optical waveguide core layer 2 includes a double-layer optical waveguide dielectric thin film 21 with the same thickness and a thin film material interlayer 22 arranged between the double-layer optical waveguide dielectric thin film 21. The optical waveguide dielectric thin film 21 generally uses doped silica with positive thermal-optical coefficient. The thin film material interlayer 22 is a negative thermo-optical coefficient material used for performing thermo-optical coefficient compensation on the optical waveguide dielectric thin film 21. Specifically, the thin film material interlayer 22 is one of the following negative thermo-optical coefficient materials: titanium dioxide, zinc oxide and magnesium doped zinc oxide.

The thin film material interlayer 22 is a two-dimensional lattice sub-wavelength structure which includes lattice points 221. The two-dimensional lattice sub-wavelength structure is Bravais lattice structure or quasicrystal structure, the Bravais lattice comprised of square or hexagons, and the shape of the quasicrystal structure is octagon or decagon or dodecagon. Please refer to FIG. 2, the two-dimensional lattice array is an abstract diagram, the lattice points 221 is the location of the centroid of the crystal cell, and the lattice constant Λ is the side length of the crystal cell, which can be regarded as the distance between two adjacent lattice points 221 in FIG. 2. The lattice points 211 is one of oval, criss-cross, hexagonal and octagonal.

In this embodiment, the thin film optical waveguide is prepared from a silica substrate 1, a double-layer optical waveguide dielectric thin film 21 with 2% germanium doped silica, a titanium dioxide thin film material interlayer 22, and a silica cladding layer that cladding the double-layer optical waveguide thin film 21 and the thin film material interlayer 22. Wherein the titanium dioxide thin film material interlayer 22 is a two-dimensional lattice subwavelength structure with square Bravais lattice, and the lattice points 221 is circular. The optical waveguide dielectric film 21 in the thin film optical waveguide is the main optical waveguide structure, which ensures the single-mode working of the thin film optical waveguide. The two-dimensional lattice sub-waveguide structure formed in the thin film interlayer 22 can be regarded as single-mode optical waveguide structure of homogeneous medium. Meanwhile, the effective refractive index of the thin film optical waveguide can be obtained by adjusting the lattice constant and the duty cycle of the two-dimensional lattice sub-waveguide structure.

In the design of the thin film optical waveguide structure, this embodiment is guided by Scalar Heimholtz formula, that is:

∇²Ψ(x,y,z)+k₀²n²(x,y)Ψ(x,y,z)=0

Where, Ψcan be any field component, k₀ is the vacuum wave number, n is the refractive index, z direction is the propagation direction, x and y are the vertical and horizontal directions of the cross section respectively. In order to obtain the solution of this formula, it can be simplified by the effective refractive index method as follows:

$$\frac{1}{F ( x , y )} \frac{{δ}^{2} F}{δ {x}^{2}} + {k}_{0}^{2} {n}^{2} ( x , y ) = {k}_{0}^{2} {n}_{eff}^{2} ( y )$$

$$\frac{1}{G ( y )} \frac{{d}^{2} G}{{dy}^{2}} - {β}^{2} = - {k}_{0}^{2} {n}_{eff}^{2} ( y )$$

Where, F and G are mode field distributions, n_{eff} is the effective refractive index, βis the propagation constant. The propagation constant and effective refractive index of the optical waveguide can be calculated by this method.

Now, taking the thin film optical waveguide shown in this embodiment as an example, the wavelength of the incident light is selected as 1550 nm, and the influence of the thin film material interlayer 22 prepared by titanium dioxide with negative thermo-optical coefficient on the effective thermo-optical coefficient of thin film optical waveguide is explained in detail.

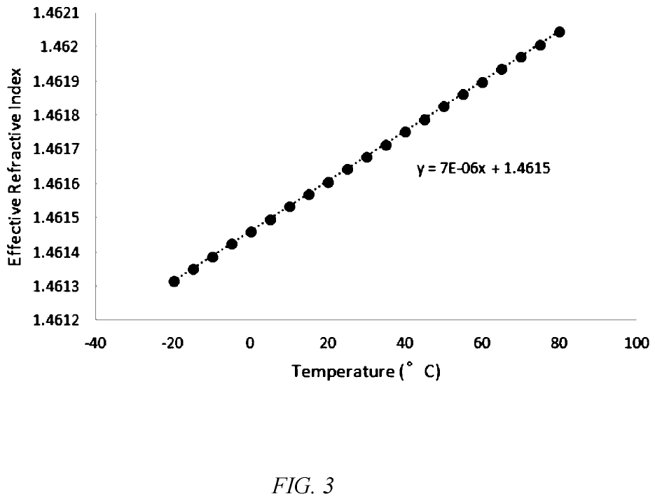

Please refer to FIG. 3, the effective thermo-optical coefficient of the thin film optical waveguide is the change rate of effective refractive index with temperature, which can be obtained from the slope of the curve by the effective refractive index at different temperatures. In FIG. 3, the compensated effective thermo-optical coefficient of the thin film optical waveguide is 7.31×10⁻⁶.

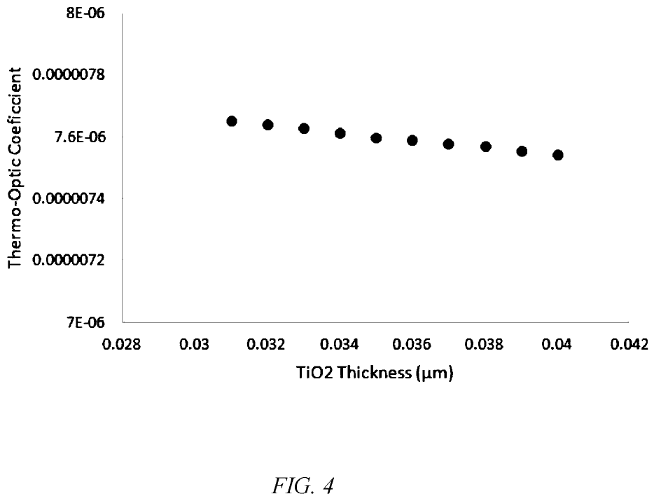

Since the overall width of the titanium dioxide thin film material interlayer 22 (i.e. the width of the thin film optical waveguide) has little influence on the effective thermo-optical coefficient of the thin film optical waveguide, it will not be investigated here. Referring to FIG. 4, the effective thermal-optical coefficient of the thin film optical waveguide produced by different thickness of titanium dioxide decreases with the increase of the thickness of titanium dioxide, and the effective thermo-optical coefficient in kept below 10⁻⁵, which means the effective thermal-optical coefficient of the material with negative thermal-optical coefficient is negatively correlated with the thickness of the material, and the effective thermal-optical coefficient of the thin film waveguide is greatly reduced and close to zero, thus the effective refractive index variation of the thin film waveguide decreases greatly with the change of temperature.

In this embodiment, according to the thin film optical waveguide with the two-dimensional lattice sub-wavelength structure, the negative thermal-optical coefficient material is prepared into the thin film material interlayer 22, so as to compensate the positive thermal-optical coefficient of the double-layer optical waveguide dielectric thin film 21, the effective thermal-optical coefficient of the thin film optical waveguide is greatly reduced and close to zero, and the thermal stability of the thin film optical waveguide is improved.

The invention also provides a preparation method for preparing the thin film optical waveguide, and the preparation method is as follows:

S1, providing the silicon-based substrate 1, specifically silica substrate 1, coating the doped silica on the silica substrate 1 by PECVD (Plasma Enhanced Chemical Vapor Deposition) to form a lower optical waveguide dielectric thin film, in which the doped silica material is 2% germanium doped silica;

S2, preparing a thin film material interlayer 22 with titanium dioxide material by ALD (Atomic Layer Deposition);

S3, making the titanium dioxide thin film material interlayer into the two-dimensional lattice sub-wavelength structure by NIL (Nanoimprint Lithography) or electronbeam lithography or optical lithography, wherein, the two-dimensional lattice sub-waveguide structure includes lattice points 221, the lattice points 221 is cycle;

S4, coating 2% germanium doped silica material by PECVD to prepare the upper optical waveguide dielectric thin film, the lower optical waveguide dielectric thin film and the upper optical waveguide dielectric thin film form the double-layer optical waveguide dielectric film 21;

S5, preparing a silica cladding layer on the outer circumference of the double-layer optical waveguide dielectric film 21 and the thin film material interlayer 22.

To sum up, the thin film material interlayer of the thin film optical waveguide provided by the present invention is a negative thermal-optical coefficient material, which is used to perform thermo-optical coefficient compensation on the optical waveguide dielectric thin film, so an additional negative thermo-optical coefficient coating does not need to be arranged, so as to reduce the complexity and cost of the process, ensure the uniform temperature control, simplify the structure of the thin film optical waveguide, and ensure the thermal stability of the thin film optical waveguide.

The technical features of the above embodiments can be combined arbitrarily, in order to make the description concise, not all possible combinations of the technical features in the above embodiments are described. However, as long as there is no contradiction between the combination of these technical features, they shall be considered to be within the scope of this specification.

The present invention only described several above embodiments, which are described more specific and detailed, but it cannot be understood as a limitation on the scope of the present invention. It should be pointed out that for ordinary technical personnel in the art, without departing from the concept of the present invention, a number of deformation and improvements can be made, which belong to the scope of the present invention. Therefore, the scope of the present invention shall be subject to the recorded claims.

1. A thin film optical waveguide, including a silicon-based substrate and a cladding layer arranged on the silicon-based substrate, and is characterized by further including an optical waveguide core layer arranged on the silicon-based substrate, wherein the optical waveguide core layer is arranged in the cladding layer, the refractive index of the optical waveguide core layer is higher than that of the cladding layer, the optical waveguide core layer comprises a double-layer optical waveguide dielectric thin film and a thin film material interlayer arranged between the double-layer optical waveguide dielectric thin film, the thin film material interlayer has a two-dimensional lattice sub-wavelength structure, and the thin film material interlayer is a negative thermo-optical coefficient material used for performing thermo-optical coefficient compensation on the optical waveguide dielectric thin film.

2. The thin film optical waveguide according to claim 1, characterized in that the negative thermo-optical coefficient material is one of titanium dioxide, zinc oxide and magnesium doped zinc oxide.

3. The thin film optical waveguide according to claim 1, characterized in that the effective thermo-optical coefficient of the negative thermo-optical coefficient material is inversely related to the thickness of the negative thermo-optical coefficient material.

4. The thin film optical waveguide according to claim 1, characterized in that the optical waveguide dielectric thin film is a positive thermo-optical coefficient material.

5. The thin film optical waveguide according to claim 1, characterized in that the optical waveguide dielectric thin film is doped silica.

6. The thin film optical waveguide according to claim 5, characterized in that the doped silica is 2% germanium doped silica.

7. The thin film optical waveguide according to claim 1, characterized in that the two-dimensional lattice sub-wavelength structure is Bravais lattice structure or quasicrystal structure.

8. The thin film optical waveguide according to claim 7, characterized in that the Bravais lattice structure is comprised of square or hexagon.

9. The thin film optical waveguide according to claim 7, characterized in that the quasicrystal structure is octagon or decagon or dodecagon.

10. The thin film optical waveguide according to claim 1, characterized in that the two-dimensional lattice sub-wavelength structure comprises lattice points that are one of circular, elliptical, criss-cross, hexagonal, and octagonal.

11. A preparation method of the thin film optical waveguide according to claim 1, characterized in that the preparation method is as follows:
S1, providing a silicon-based substrate, and forming a lower optical waveguide dielectric thin film on the silicon-based substrate;
S2, preparing a thin film material interlayer by using a negative thermo-optical coefficient material;
S3, preparing the thin film material interlayer into the two-dimensional lattice sub-wavelength structure;
S4, preparing an upper layer optical waveguide dielectric thin film, wherein the lower layer optical waveguide dielectric thin film and the upper layer optical waveguide dielectric thin film form the double-layer optical waveguide dielectric thin film;
S5, preparing the cladding layer.
